(19) United States
(12) Patent Application Publication
(10) Pub. No.: US 2004/0042205 A1
(43) Pub. Date: Mar. 4, 2004

(54) Circuit for illuminator

(75) Inventors: Tetsuo Tanabe, Nishikasugai-gun (JP); Shigeaki Tauchi, Tokyo (JP)

Correspondence Address: MCGINN & GIBB, PLLC, 8321 OLD COURTHOUSE ROAD, SUITE 200, VIENNA, VA, 22182-3817, US

(73) Assignee: Toyoda Gosei Co., Ltd., Nishikasugai-gun (JP)

(21) Appl. No.: 10/652,513

(22) Filed: Sep. 2, 2003

(30) Foreign Application Priority Data
Sep. 3, 2002 (JP) P2002-257682

(51) Int. Cl. F21L 4/00

(52) U.S. Cl. 362/189

(57) ABSTRACT

A circuit for an illuminator includes LEDs (DL1, . . . , DL6) which are connected to resistors (R1, . . . , R6) respectively in series to provide six series units and twos of these series units therein are connected in parallel and moreover threes of these parallel units are connected in series in a lattice arrangement. Even when DL2 undergoes disconnection, for example, an increased amount of current flowing in DL1 can thus be restrained as much as possible and even when LEDs with variable forward voltage are connected in parallel, a difference in the flowing amount of current between the LEDs is minimized and a difference in brightness is substantially nullified. Moreover, as resistors are added to the respective units, the number of LEDs can freely be changed by directly connecting units with the omission of the LED.

The present application is based on Japanese Patent Application No. 2002-257682, which is incorporated herein by reference.

### BACKGROUND OF THE INVENTION

1. Field of the Invention

The present invention relates to a circuit for an illuminator such as a direction indicator (winker), a rear lighting equipment, a headlamp, a stop lamp including a high mounted stop lamp and a rear combination lamp, all using a plurality of light emitting diodes (hereinafter also called ‘LED’) as light sources.

2. Description of the Related Art

A conventional stop lamp will be described by reference to FIGS. 12 to 14. FIG. 12 is a conventional circuit diagram showing a stop lamp circuit for lighting a plurality of light emitting diodes connected in a lattice arrangement. FIG. 13 is a graph showing the relation between forward voltage Vf and forward current If of a light emitting diode in general. FIG. 14 is a circuit diagram referring to a case where five light emitting diodes are employed in a conventional stop lamp.

As shown in FIG. 12, six of the LEDs (DL1, DL2, DL3, DL4, DL5, DL6) are used to provide two-series and three-parallel arrangements. Moreover, a reverse-connection protective diode D and a current-limiting resistor R are connected in series.

The following are the problems concerned with the conventional circuit.

(1) In case that one of the LEDs undergoes disconnection, a current almost twice as large as what has been flowing therethrough is cause to flow through another LED connected in parallel thereto and this results in leaving no margin for the maximum rated current. (2) As shown in FIG. 13, the relation between forward voltage Vf and forward current If of the light emitting diode in general is such that when Vf acquires a given value or greater, If changes greatly even if Vf slightly changes. The value of Vf often varies from LED to LED even though the LEDs are of the same kind. In the conventional system, a greater current flows toward the LED having a smaller value of Vf and the current in what has a greater value of Vf decreases when LEDs having different values of Vf are connected in parallel, thus causing a difference in brightness to grow larger therebetween. Accordingly, Vf values of LEDs to be used have been measured one by one to sort out a group of LEDs at roughly ±10 mV and this has required a great deal of time. (3) In case that it is attempted to set five LEDs in order to meet the makeup requirements, the LEDs connected in a lattice arrangement in the conventional system are formed as seen in FIG. 14 and the current caused to flow from DL1 to DL4 differs from what flows into DL5. In other words, the conventional arrangement is not applicable to the case of five LEDs.

### SUMMARY OF THE INVENTION

An object of the invention is to provide a circuit for an illuminator such that a flow of current in LEDs connected in parallel is restrained as much as possible even if disconnection occurs; brightness is substantially uniformized even though LEDs different in the value of Vf are connected in parallel; and any number of LEDs are usable.

A circuit for an illuminator according to the present invention has a plurality of units each comprising a light emitting diode and a resistor which are connected in series, wherein the plurality of units are connected in parallel to form at least one parallel circuit. A plurality of the parallel circuits may be further connected in series to form a lattice network.

As the current limiting resistors are connected in series to the respective LEDs connected in parallel in the units, a current of approximately 1.5 times as much flows therethrough, whereas a current of approximately twice as much flows in the conventional circuit when disconnection occurs. Consequently, a margin for the maximum permissible current of LED is increased. Even when LEDs different in the value of Vf are connected in parallel, a difference in If due to a difference in Vf therebetween is leveled off because the resistors are added to the respective units, so that a substantially uniform current flows in each LED. As the luminance of the LED is proportional to the current, brightness of both LEDs becomes substantially uniformized.

Thus the flow of the current in the other LED connected to one LED in parallel is retrained as much as possible even when disconnection occurs and a margin for the maximum rated current becomes easy to secure and moreover variations in the luminance of the LED at the time disconnection occurs can be restrained. Further, even though LEDs having different values of Vf are connected in parallel, it is possible to provide a circuit for an illuminator formed with LEDs offering substantially uniform brightness in their usual ON state as variations in the flow of the current in each of the LEDs are suppressed.

The circuit for an illuminator according to the invention may have a series unit without having the light emitting diode, and the series unit is incorporated in at least one of the parallel circuits. The series unit may be constituted by forming a short circuit between terminals to be fitted with an anode and cathode of the light emitting diode without coupling the light emitting diode. Further, the short circuit may be formed of a jumper line.

As a jumper line or the like is used for forming a short-circuit between terminals for mounting the LED in the unit without having the light emitting diode, the number of LEDs for use can freely be set within the range of the existing circuit.

The circuit for an illuminator according to the invention may have a dummy diode incorporated in place of the light emitting diode in the unit.

As the diodes as dummies in place of the LED is employed in the unit without having the LED, Vf applied to another parallel-related LED is made controllable, so that the circuit for an illuminator can offer substantially uniform brightness in its usual ON state.

### BRIEF DESCRIPTION OF THE DRAWINGS

In the accompanying drawings:

FIG. 1 shows a circuit diagram showing a stop lamp circuit according to Embodiment 1 of the invention;

FIG. 2 shows a graph showing Vf-If characteristics of LEDs;

FIG. 3A shows a circuit diagram before the breaking down of the LED occurs in a conventional system, and FIG. 3B, a circuit diagram after the breaking down of the LED occurs;

FIG. 4A shows a circuit diagram before the breaking down of the LED occurs in the circuit according to Embodiment 1 of the invention, and FIG. 4B, a circuit diagram after the breaking down of the LED occurs;

FIG. 5 shows a graph showing Vf-If characteristics when the Vf of the LED is variable;

FIG. 6 shows a diagram of LEDs connected in parallel in part of the conventional circuit, the LEDs showing variations in Vf;

FIG. 7 shows a diagram of LEDs connected in parallel in part of the circuit according to Embodiment 1 of the invention, the LEDs showing variations in Vf;

FIG. 8 shows a circuit diagram showing a light emitting circuit of a stop lamp according to Embodiment 2 of the invention;

FIGS. 9A and 9B show circuit diagrams showing a light emitting circuit of a stop lamp as a modified Embodiment 2 of the invention;

FIG. 10 shows a circuit diagram showing a light emitting circuit of a stop lamp according to Embodiment 3 of the invention;

FIG. 11 shows a circuit diagram showing a light emitting circuit of a stop lamp according to Embodiment 4 of the invention;

FIG. 12 shows a circuit diagram showing a conventional stop lamp circuit for lighting a plurality of light emitting diodes connected in a lattice arrangement; and

FIG. 13 shows a graph showing the relation between forward voltage Vf and forward current If of a light emitting diode in general; and

FIG. 14 shows a circuit diagram referring to a case where five light emitting diodes are employed in a conventional stop lamp.

### DETAILED DESCRIPTION OF THE PREFERRED EMBODIMENTS

Embodiments of the invention will now be described by reference to the drawings.

Embodiment 1

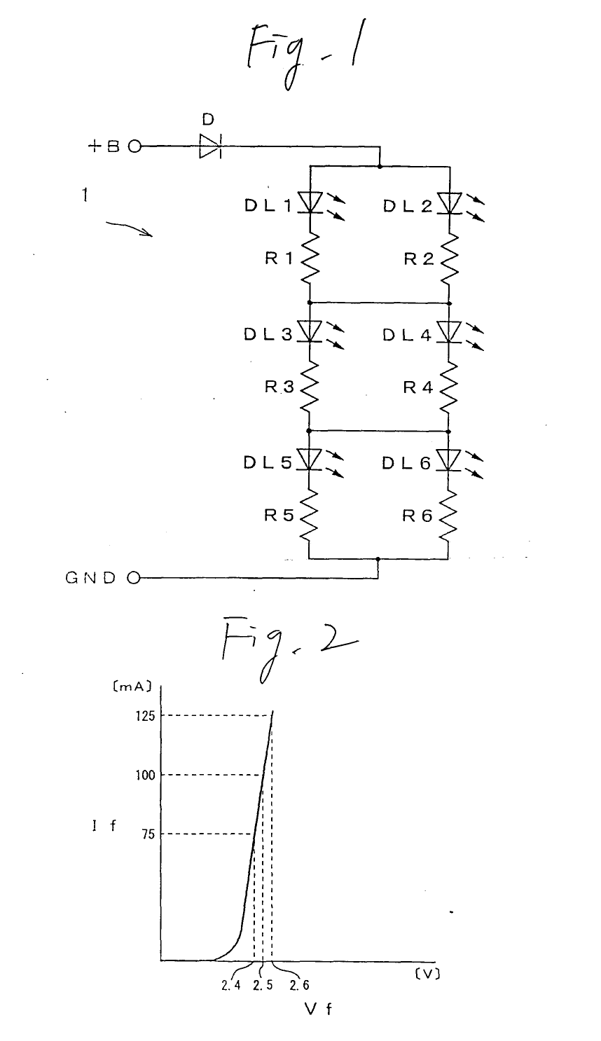

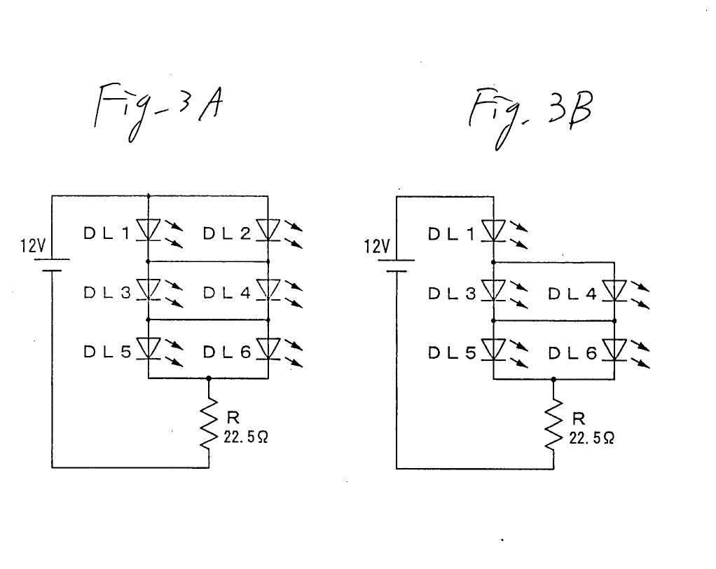

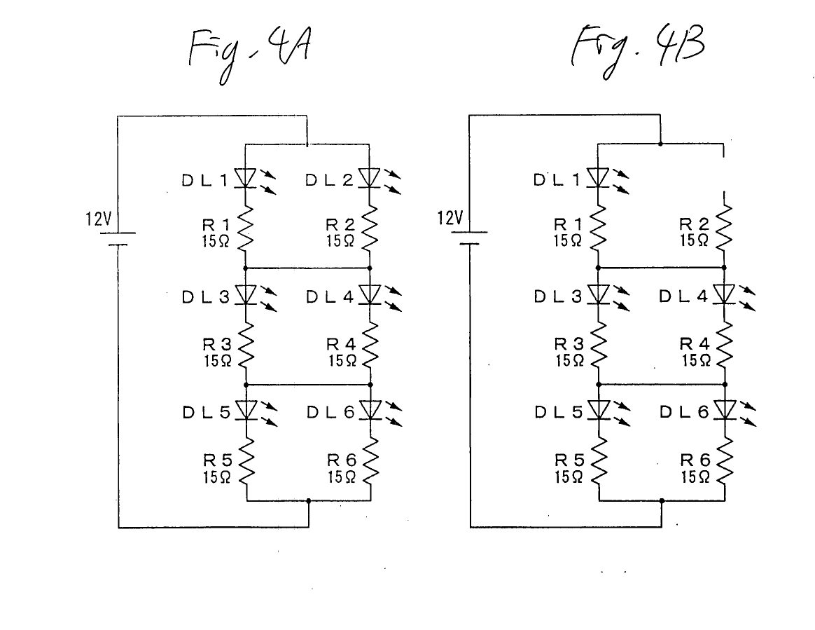

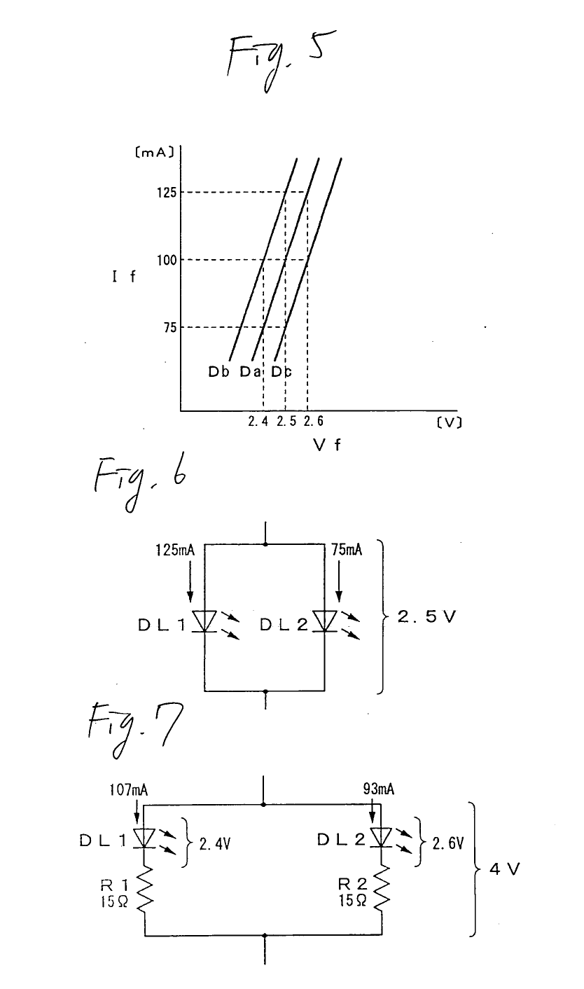

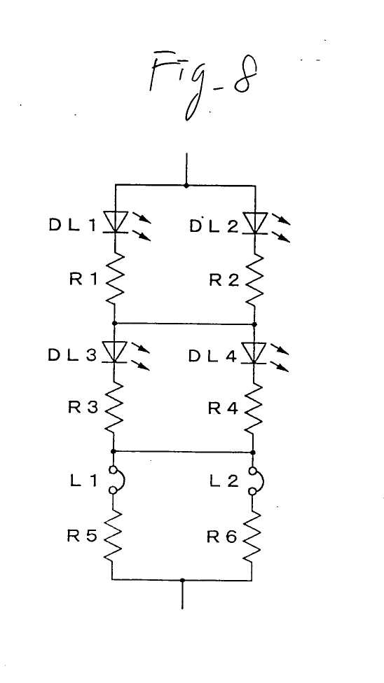

First, a stop lamp according to Embodiment 1, in which a circuit for an illuminator according to the invention is used will be described by reference to FIGS. 1 to 7. FIG. 1 is a circuit diagram showing a stop lamp circuit according to Embodiment 1 of the invention. FIG. 2 is a graph showing Vf-If characteristics of LEDs. FIG. 3A shows a circuit diagram before the breaking down of the LED occurs in a conventional system; and FIG. 3B, a circuit diagram after the breaking down of the LED occurs. FIG. 4A shows a circuit diagram before the breaking down of the LED occurs in the circuit according to Embodiment 1 of the invention; and FIG. 4B, a circuit diagram after the breaking down of the LED occurs. FIG. 5 is a graph showing Vf-If characteristics when the Vf of the LED is variable. FIG. 6 is a diagram of LEDs connected in parallel in part of the conventional circuit, the LEDs showing variations in Vf. FIG. 7 is a diagram of LEDs connected in parallel in part of the circuit according to Embodiment 1 of the invention, the LEDs showing variations in Vf.

As shown in FIG. 1, the circuit of a stop lamp 1 according to Embodiment 1 of the invention is in the form of a lattice network in which LEDs (DL1, DL2, DL3, DL4, DL5, DL6) are connected to resistors (R1, R2, R3, R4, R5, R6) respectively in series to provide six series units and twos of these series units therein are connected in parallel and moreover threes of these parallel units are connected in series. Thus the six LEDs are connected in a lattice arrangement so as to form a light emitting portion in two-series and three-parallel arrangements. The reason for connecting the LEDs in such a lattice arrangement is that any rear combination lamp out of stop lamps is so regulated that the whole LED therein shall not go out even when the breaking down of one LED occurs. Further, a reverse-connection protective diode D is connected to the lattice circuit. The resistors connected to the respective LEDs are properly decided in accordance with the circuit arrangement and Vf-If characteristics of the LEDs.

A description will now be given of the characteristics of the stop lamp thus arranged according to Embodiment 1 of the invention and a stop lamp according to modified Embodiment 1 thereof with reference to a case where light emitting diodes having Vf-If characteristics as shown in FIG. 2 are employed. First, the effect of a case where one LED is broken down will be described by citing a conventional circuit for comparison. Assuming that a current of 100 mA is flowing in LEDs with a power supply voltage at 12V, 100 mA is flowing uniformly in each of the LEDs in the conventional circuit of FIG. 3A. When a simulation is done with respect to the circuit corresponding to the situation in which the breaking down of the LED•DL2 occurs as shown in FIG. 3B, a current of 189 mA is caused to flow in the LED•DL1 connected to the LED•DL2 in parallel.

In the circuit with the same LEDs used and with a power supply voltage at 12V according to Embodiment 1 of the invention as shown in FIG. 4A, 100 mA is flowing uniformly in each of the LEDs. When a simulation is done with respect to the circuit corresponding to the situation in which the breaking down of the LED•DL2 occurs as shown in FIG. 4B, a current of 152 mA is caused to flow in the LED•DL1 connected to the LED•DL2 in parallel.

When one LED is thus broken down, a current approximately 1.9 times as much flows in the LED connected to the broken-down LED in parallel in the conventional circuit, whereas such a current is reducible to approximately 1.5 times as much in the circuit according to Embodiment 1 of the invention, whereby a margin for the maximum permissible current of LED is increased.

The effect of a case where the forward voltage of the LED is variable will subsequently be described by citing the conventional circuit for comparison. In this case, consideration is given to a case where Db with Vf at 2.4 V and Dc with Vf at 2.6 V resulting from variations in Vf are connected in parallel to Da whose forward voltage Vf is 2.5V when 100 mA is caused to flow as shown in FIG. 2. Provided both Db and Dc are similar in characteristic to each other, the Vf-If characteristics are as shown in FIG. 5.

In the conventional circuit, assuming that Db is connected to the position of DL1 and that Dc is connected to the position of DL2 and further assuming that Vf of both LEDs is 2.5 V as shown in FIG. 6, a current of 125 mA and a current of 75 mA flow in DL1 and DL2, respectively. As the luminance of the LED is proportional to the current, there is produced a difference in brightness approximately 1.67 times as much between both the LEDs.

In the circuit according to Embodiment 1 of the invention, on the other hand, assuming that Db is connected to the position of DL1 and that Dc is connected to the position of DL2, there follows the result shown in FIG. 7. As the power supply voltage is 12V, 4V as the power supply voltage is applied to the two units, whereby when the current in each LED is simply taken into consideration,

current of (4−2.4)/15=0.107 (A)

is caused to flow in DL1, whereas

current of (4−2.6)/15=0.093 (A)

is caused to flow in DL2. Therefore, the ratio of both the LEDs comes to approximately 1.15 times as much and a difference in brightness becomes by far smaller than that in the conventional circuit.

Thus the whole LED in the stop lamp according to Embodiment 1 of the invention is prevented by the lattice circuit from completely going out despite the occurrence of the breaking down of even one LED and the flow of the current in the LEDs connected in parallel can be restrained. Moreover, a margin for the maximum rated current becomes easy to secure and variations in the brightness of LEDs can be restrained at the time disconnection occurs. Even though LEDs having different Vf values are connected in parallel, it is possible to provide a stop lamp formed with LEDs offering substantially uniform brightness in their usual on state as variations in the flow of the current in each of the LEDs are suppressed. Consequently, the routine work of sorting out LEDs having Vf values close to each other can greatly be decreased and this results in curtailing the production cost.

The stop lamp thus provided is highly reliable in that while the whole LED therein is prevented from completely going out despite the occurrence of partial breakdown, variations in brightness can be suppressed.

Embodiment 2

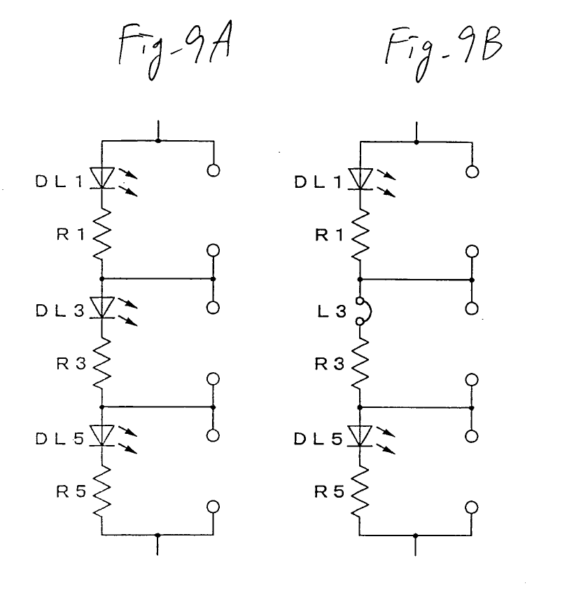

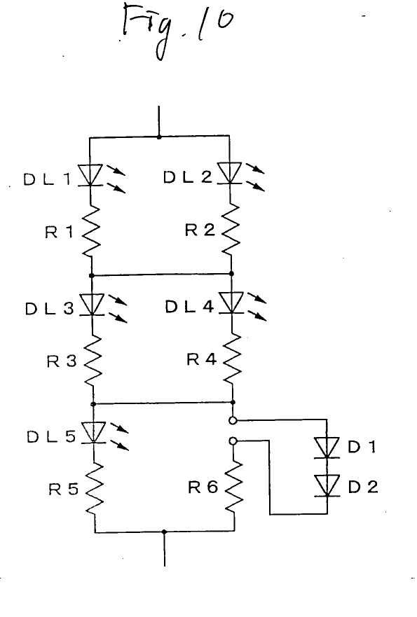

A stop lamp according to Embodiment 2 of the invention will be described by reference to FIGS. 8 and 9 next. FIG. 8 is a circuit diagram showing a light emitting circuit of a stop lamp according to Embodiment 2 of the invention; and FIGS. 9A and 9B, circuit diagrams showing a light emitting circuit of a stop lamp as a modified Embodiment 2 thereof.

As shown in FIG. 8, in order to deal with less than six LEDs in the stop lamp according to Embodiment 2 of the invention, units without having LEDs respectively employ jumper wires L1 and L2 for forming a short-circuit between terminals to be fitted with the anode and cathode of the LED. Thus four LEDs are provided. Further, FIGS. 9A and 9B show light emitting circuit diagrams with three LEDs and two LEDs. In the case of three LEDs, three series units on one side are connected together, whereas in the case of two LEDs, a unit without having any LED employs a jumper wire L3 for forming a short-circuit between terminals to be fitted with the anode and cathode of the LED. FIGS. 9A and 9B show structures of the incomplete circuit, wherein any electric part is coupled between the terminals to form a complete circuit.

As the unit without having the LED may employ the jumper wire for forming a short circuit between terminals for mounting the LED, the number of LEDs for use can freely be set. Consequently, any number of LEDs are usable in the stop lamp. In the parallel-related units, however, light emission becomes feeble when the LED is arranged in one unit and when the jumper wire is arranged in the other because the current caused to flow toward the LED is none too much. Therefore, dummy diodes to be described in Embodiment 3 that follows will be required in such a case as this. Moreover, the board manufacturing cost can be brought down as there is a certain degree of freedom for changing the number of LEDs even though the same board is employed.

Embodiment 3

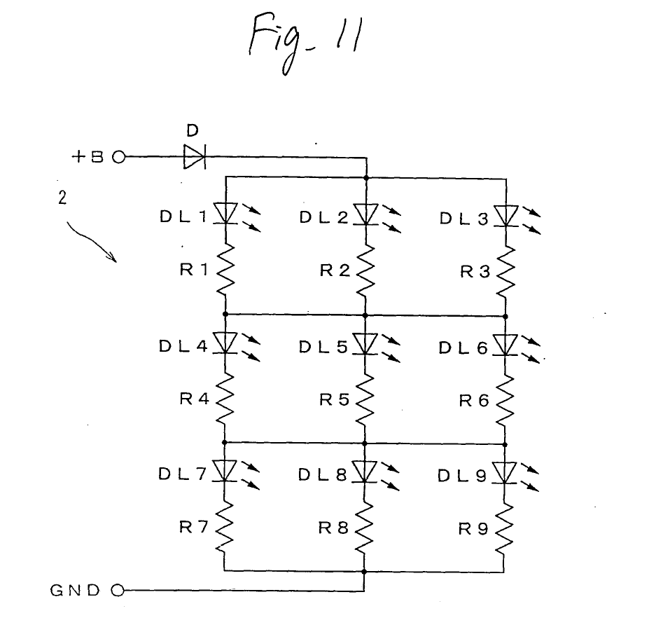

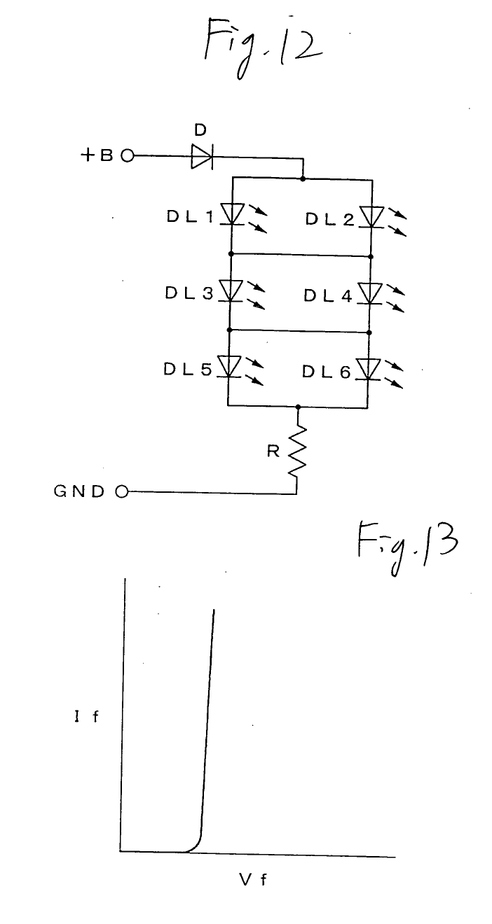

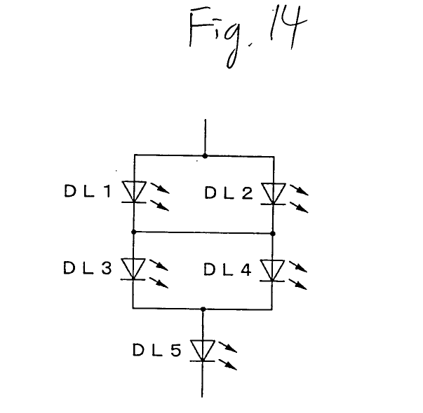

A stop lamp according to Embodiment 3 of the invention will be described by reference to FIG. 10 next. FIG. 10 is a circuit diagram showing a light emitting circuit of a stop lamp according to Embodiment 3 of the invention.

As shown in FIG. 10, in order to deal with five LEDs in the stop lamp according to Embodiment 3 of the invention, two ordinary diodes D1 and D2 as dummies are connected in series to a unit without having LED. However, the two dummy diodes D1 and D2 are selected so that the total forward voltage of these two diodes is close in value to the forward voltage value of the LED•DL5.

The reason for the use of the dummy diodes is to balance Vf in case where the LED exists on one side and where the LED is nonexistent on the other. Therefore, in the case of six units in two-series and three-parallel arrangements as in the preceding embodiments of the invention, Embodiment 3 thereof is applied only when five LEDs are employed. When the LED is replaced with the dummy diodes, a special replacement circuit for installing the dummy diodes D1 and D2 is needed as shown in FIG. 10.

Since the diodes instead of the LED are usable as dummies to be connected to the unit without having the LED, the number of LEDs for use can freely be set. Thus any number of LEDs are allowed to be set in a stop lamp of this kind.

Embodiment 4

A stop lamp according to Embodiment 4 of the invention will be described by reference to FIG. 11 next. FIG. 11 is a circuit diagram showing a light emitting circuit of a stop lamp according to Embodiment 4 of the invention.

As shown in FIG. 11, the circuit of a stop lamp 2 according to Embodiment 4 of the invention is such that LEDs (DL1, . . . , DL9) are connected to resistors (R1, . . . , R9) respectively in series to provide nine units in three-series and three-parallel light emitting lattice circuit arrangements, whereby a brighter stop lamp is made. Moreover, a reverse-connection protective diode D is connected to the lattice circuit in series.

As in the case of Embodiment 1 of the invention, even when any one of the LEDs (ex. DL1) undergoes disconnection, an increased amount of current flowing in two LEDs (DL2 and DL3) connected to the DL1 can be restrained as much as possible, whereby a margin for the maximum permissible current of LED is increased. Even when the LEDs with variable forward voltage are connected in parallel, a difference in the flowing amount of current between the LEDs is minimized and a difference in brightness is substantially nullified.

As the resistors are added to the respective units in the circuit according to Embodiment 4 of the invention, the number of LEDs can freely be changed by connecting dummy diodes in place of the LED to the units and this arrangement is usable for dealing with the case of seven or eight LEDs likewise.

The formation, configuration, quantity, material, size, connection and the like of any other component of the stop lamp are not limited to those described in the embodiments of the invention.

Although the invention has been described with reference to the embodiments of the stop lamp, the invention is needless to say applicable to any circuit for an illuminator comprising a plurality of LEDs in a direction indicator (winker), a rear lighting equipment, a headlamp and so forth which require a certain degree of luminance.

As set forth above, a circuit for an illuminator according to the present invention has a plurality of units each comprising a light emitting diode and a resistor which are connected in series, wherein the plurality of units are connected in parallel to form at least one parallel circuit. A plurality of the parallel circuits may be further connected in series to form a lattice network.

As the current limiting resistors are connected in series to the respective LEDs connected in parallel in the units, a current of approximately 1.5 times as much flows therethrough, whereas a current of approximately twice as much flows in the conventional circuit when disconnection occurs. Consequently, a margin for the maximum permissible current of LED is increased. Even when LEDs different in the value of Vf are connected in parallel, a difference in If due to a difference in Vf therebetween is leveled off because the resistors are connected to the respective units, so that a substantially uniform current flows in each LED. As the luminance of the LED is proportional to the current, brightness of both LEDs becomes substantially uniformized.

Thus the flow of the current in the other LED connected to one LED in parallel is retrained as much as possible even when disconnection occurs and a margin for the maximum rated current becomes easy to secure and moreover variations in the luminance of the LED at the time disconnection occurs can be restrained. Further, even though LEDs having different values of Vf are connected in parallel, it is possible to provide a circuit for an illuminator formed with LEDs offering substantially uniform brightness in their usual ON state as variations in the flow of the current in each of the LEDs are suppressed.

The circuit for an illuminator according to the invention may have a series unit without having the light emitting diode, and the series unit is incorporated in at least one of the parallel circuits. The series unit may be constituted by forming a short circuit between terminals to be fitted with an anode and cathode of the light emitting diode without coupling the light emitting diode. Further, the short circuit may be formed of a jumper line.

As the jumper line or the like is used for forming a short-circuit between terminals for mounting the LED in the unit without having the light emitting diode, the number of LEDs for use can freely be set within the range of the existing circuit.

The circuit for an illuminator according to the invention may have a dummy diode incorporated in place of the light emitting diode in the unit.

As the diodes as dummies in place of the LED is employed in the unit without having the LED, Vf applied to another parallel-related LED is made controllable, so that the circuit for an illuminator can offer substantially uniform brightness in its usual ON state.

The present invention is not limited to the mode for carrying out the invention and the embodiment thereof at all, and includes various modifications that can be conceived easily by those skilled in the art, without departing from the gist of the invention.

What is claimed is:

1. A circuit for an illuminator comprising a plurality of units each comprising a light emitting diode and a resistor which are connected in series, wherein said plurality of units are connected in parallel to form a parallel circuit, and a plurality of said parallel circuits are further connected in series to form a lattice network.

2. A circuit for an illuminator according to claim 1, further comprising a series unit without having the light emitting diode, said series unit being incorporated in at least one of said parallel circuits.

3. A circuit for an illuminator according to claim 2, wherein said series unit is constituted by forming a short circuit between terminals to be fitted with an anode and cathode of the light emitting diode without coupling the light emitting diode.

4. A circuit for an illuminator according to claim 3, wherein said short circuit comprises a jumper line.

5. A circuit for an illuminator according to claim 1, further comprising a dummy diode incorporated in place of the light emitting diode in the unit.

6. A stop lamp comprising the circuit according to claim 1.

7. A direction indicator comprising the circuit according to claim 1.

8. A rear lighting equipment comprising the circuit according to claim 1.

9. A headlamp comprising the circuit according to claim 1.
